(19) United States
(12) Patent Application Publication
(10) Pub. No.: US 2025/0304261 A1
(43) Pub. Date: Oct. 2, 2025

(54) BLEEDLESS ENVIRONMENTAL CONTROL SYSTEM

(71) Applicant: Hamilton Sundstrand Corporation, Charlotte, NC (US)

(72) Inventors: Louis J. Bruno, Ellington, CT (US); Kayla Gosse, Ellington, CT (US); Aiden Coutin, Ogden, UT (US)

(21) Appl. No.: 19/018,471

(22) Filed: Jan. 13, 2025

Related U.S. Application Data
(60) Provisional application No. 63/573,057, filed on Apr. 2, 2024.

(51) Int. Cl. B64D 13/02; B64D 13/06; B64D 13/08

(52) U.S. Cl. CPC B64D 13/02; B64D 13/08; B64D 2013/0644; B64D 2013/0648

(57) ABSTRACT

An environmental control system of a vehicle includes an air conditioning system having a first inlet configured to receive a first medium and a second inlet configured to receive a second medium. An air supply system including a thermodynamic device is fluidly coupled to the air conditioning system. The thermodynamic device includes a compressor operably coupled to an electric motor and a turbine by a shaft. T the thermodynamic device is fluidly coupled to and is arranged upstream from the first inlet relative to a flow of the first medium and the thermodynamic device is fluidly coupled to and is arranged downstream from the second inlet relative to a flow of the second medium. The electric motor is fluidly coupled to an inlet of the turbine and the turbine is arranged directly downstream from the electric motor relative to the flow of the second medium.

### CROSS-REFERENCE TO RELATED APPLICATIONS

This application claims the benefit of U.S. Application No. 63/573,057 filed Apr. 2, 2024, the contents of which are incorporated by reference herein in its entirety.

### BACKGROUND

Embodiments of the disclosure relate to environmental control systems, and more specifically to an environmental control system of an aircraft.

In general, contemporary air condition systems are supplied a pressure at cruise that is approximately 30 psig to 35 psig. The trend in the aerospace industry today is towards systems with higher efficiency. One approach to improve airplane efficiency is to eliminate the bleed air entirely and use electrical power to compress outside air. A second approach is to use lower engine pressure. The third approach is to use the energy in the bleed air to compress outside air and bring it into the cabin. Unfortunately, each of these approaches provides limited efficiency with respect to engine fuel burn.

### SUMMARY

According to an embodiment, an environmental control system of a vehicle includes an air conditioning system having a first inlet configured to receive a first medium and a second inlet configured to receive a second medium. An air supply system including a thermodynamic device is fluidly coupled to the air conditioning system. The thermodynamic device includes a compressor operably coupled to an electric motor and a turbine by a shaft. T the thermodynamic device is fluidly coupled to and is arranged upstream from the first inlet relative to a flow of the first medium and the thermodynamic device is fluidly coupled to and is arranged downstream from the second inlet relative to a flow of the second medium. The electric motor is fluidly coupled to an inlet of the turbine and the turbine is arranged directly downstream from the electric motor relative to the flow of the second medium.

In addition to one or more of the features described above, or as an alternative to any of the foregoing embodiments the flow of the second medium is operable to remove heat from the electric motor.

In addition to one or more of the features described above, or as an alternative to any of the foregoing embodiments the flow of the second medium is configured to make a plurality of passes over the electric motor.

In addition to one or more of the features described above, or as an alternative to any of the foregoing embodiments the air conditioning system includes a ram air circuit having at least one ram heat exchanger and an outlet of the turbine is fluidly connected to the ram air circuit at a location downstream from the at least one ram heat exchanger.

In addition to one or more of the features described above, or as an alternative to any of the foregoing embodiments the compressor has a compressor outlet, the compressor outlet being fluidly connected to and arranged in series with the at least one ram heat exchanger.

In addition to one or more of the features described above, or as an alternative to any of the foregoing embodiments the compressor outlet is directly fluidly connected to the at least one ram heat exchanger.

In addition to one or more of the features described above, or as an alternative to any of the foregoing embodiments in a mode, the compressor is driven solely by the electric motor.

In addition to one or more of the features described above, or as an alternative to any of the foregoing embodiments in another mode, the compressor is driven by the electric motor and by energy extracted from the second medium at the turbine.

In addition to one or more of the features described above, or as an alternative to any of the foregoing embodiments the air conditioning system includes another thermodynamic device having a compressor and at least one turbine operably coupled by a shaft.

In addition to one or more of the features described above, or as an alternative to any of the foregoing embodiments the at least one turbine of the another thermodynamic device includes a first turbine and a second turbine. The first turbine and the second turbine are arranged in series relative to a flow of the first medium.

In addition to one or more of the features described above, or as an alternative to any of the foregoing embodiments a water extractor is positioned directly downstream from an outlet of the first turbine. The first turbine and the water extractor, in combination, form a mid-pressure water separator.

In addition to one or more of the features described above, or as an alternative to any of the foregoing embodiments the environmental control system is part of an aircraft and the second medium is cabin air.

According to an embodiment, a method of operating an environmental control system of a vehicle includes compressing a first medium at an air supply system to form a compressed first medium. The air supply system includes a thermodynamic device fluidly coupled to an air conditioning system and the thermodynamic device includes a compressor operably coupled to an electric motor and a turbine by a shaft. The method includes cooling the electric motor via a flow of second medium provided from the air conditioning system and extracting energy from the flow of second medium at the turbine to form an expanded second medium. Extracting energy from the flow of second medium occurs directly downstream from the electric motor.

In addition to one or more of the features described above, or as an alternative to any of the foregoing embodiments exhausting the expanded second medium from the turbine into a ram air circuit of the air conditioning system.

In addition to one or more of the features described above, or as an alternative to any of the foregoing embodiments the ram air circuit includes at least one ram heat exchanger, and exhausting the expanded second medium into the ram air circuit occurs at a location downstream from the at least one ram heat exchanger.

In addition to one or more of the features described above, or as an alternative to any of the foregoing embodiments cooling the compressed first medium within the at least one ram heat exchanger.

In addition to one or more of the features described above, or as an alternative to any of the foregoing embodiments cooling the compressed first medium within the at least one ram heat exchanger occurs directly downstream from compressing the first medium to form the compressed first medium.

In addition to one or more of the features described above, or as an alternative to any of the foregoing embodiments cooling the compressed first medium within the at least one ram heat exchanger includes drawing a flow of ram air through the ram air circuit via a fan.

In addition to one or more of the features described above, or as an alternative to any of the foregoing embodiments the fan is driven by another motor, the method further comprising cooling the another motor with the expanded second medium.

### BRIEF DESCRIPTION OF THE DRAWINGS

The subject matter is particularly pointed out and distinctly claimed in the claims at the conclusion of the specification. The forgoing and other features, and advantages thereof are apparent from the following detailed description taken in conjunction with the accompanying drawings in which:

FIG. 1 is a schematic diagram of an electrically driven environmental control system according to an embodiment;

FIG. 2 is a schematic diagram of an electrically driven environmental control system according to an embodiment;

FIG. 3 is a schematic diagram of an electrically driven environmental control system according to an embodiment;

FIG. 4 is a schematic diagram of an electrically driven environmental control system according to an embodiment;

FIG. 5 is a schematic diagram of an electrically driven environmental control system according to an embodiment;

FIG. 6 is a schematic diagram of an electrically driven environmental control system according to an embodiment; and

FIG. 7 is a schematic diagram of an electrically driven environmental control system according to an embodiment.

### DETAILED DESCRIPTION

A detailed description of one or more embodiments of the disclosed apparatus and method are presented herein by way of exemplification and not limitation with reference to the FIGS.

Embodiments herein provide an environmental control system of an aircraft that receives multiple mediums from different sources and uses energy from one or more of the mediums to operate the environmental control system and to provide cabin pressurization and cooling at a high fuel burn efficiency. The mediums described herein are generally types of air; however, it should be understood that other mediums, such as gases, liquids, fluidized solids, or slurries are also contemplated herein.

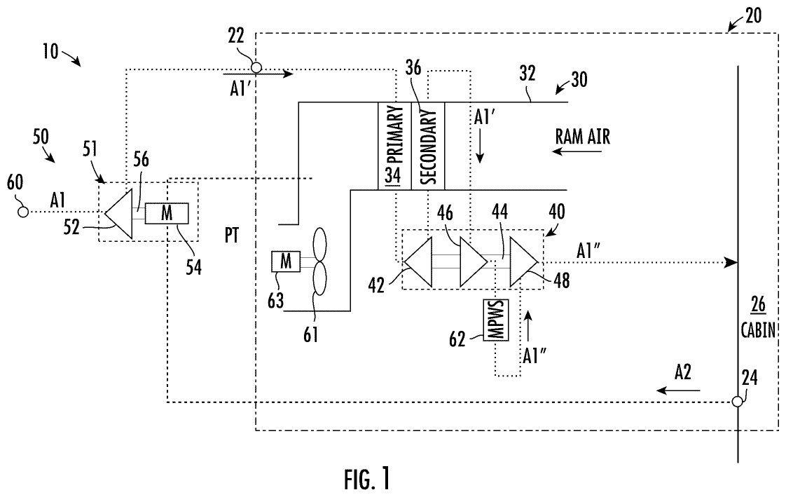

With reference now to the FIGS. 1-3, schematic diagrams of a portion of an environmental control system (ECS) 10 according to various embodiments are illustrated. As shown, the environmental control system 10 may include an air conditioning system 20 having one or more air conditioning system (ACS) packs for example, are depicted according to a non-limiting embodiment. Although the ACS or ACS pack 20 is described with reference to an aircraft, alternative applications, such as another vehicle for example, are also within the scope of the disclosure. As shown, the ACS pack 20 may be configured to receive the first medium A1 at a first inlet 22 and may provide a conditioned form of the first medium A1 to a volume 26 during normal operation. In embodiments where the ECS 10 is used in an aircraft application, the first medium A1 may be fresh air, such as outside air for example. The outside air can be procured via one or more scooping mechanisms, such as an impact scoop or a flush scoop for example. Thus, the inlet 22 can be considered a fresh or outside air inlet. In an embodiment, the first medium A1 is ram air drawn from a portion of a ram air circuit. Generally, the first medium A1 described herein may be at an ambient pressure equal to an air pressure outside of the aircraft when the aircraft is on the ground and is between an ambient pressure and a cabin pressure when the aircraft is in flight.

The ECS 10 may alternatively or additionally be configured to receive a second medium A2 at a second inlet 24. In an embodiment, the second inlet 24 is operably coupled to a volume 26, such as the cabin of an aircraft. The second medium A2 may be cabin discharge air, which is air leaving the volume 26 and that would typically be discharged overboard. In some embodiments, the ECS 10 is configured to extract work from the second medium A2, In this manner, the second medium A2 of the volume 26 can be utilized by the ECS 10 to achieve certain operations. However, it should be understood that embodiments where another medium is used as either the first and/or second medium, are also within the scope of the disclosure. In an embodiment, the ECS 10 does not receive a flow of bleed air from either an engine or an auxiliary power unit.

The ACS 20 includes a RAM air circuit 30 including a shell or duct, illustrated schematically at 32, within which one or more heat exchangers are located. The shell 32 can receive and direct a medium, such as ram air AR for example, through a portion of the ACS 20. The one or more heat exchangers are devices built for efficient heat transfer from one medium to another. Examples of the type of heat exchangers that may be used, include, but are not limited to, double pipe, shell and tube, plate, plate and shell, adiabatic shell, plate fin, pillow plate, and fluid heat exchangers.

The one or more heat exchangers arranged within the shell 32 may be referred to as ram heat exchangers. In the illustrated, non-limiting embodiment, the at least one ram heat exchanger includes a first heat exchanger 34 and a second heat exchanger 36. However, any suitable number of heat exchangers may be contemplated herein. Within the heat exchangers 34, 36, ram air, such as outside air for example, acts as a heat sink to cool a medium passing there through, for example the first medium A1. Although the plurality of ram air heat exchangers 34, 36 are illustrated as being arranged in series relative to a flow through the ram air circuit 30, it should be understood that in other embodiments, the plurality of heat exchangers may be arranged in parallel or some combination of series and parallel.

The ACS 20 additionally includes at least one thermodynamic device 40, and in some embodiments includes a plurality of thermodynamic devices. A thermodynamic device 40 is a mechanical device that includes components for performing thermodynamic work on a medium (e.g., extracts work from or applies work to the first medium A1, by raising and/or lowering pressure and by raising and/or lowering temperature). Examples of a thermodynamic device include an air cycle machine, a two-wheel air cycle machine, a three-wheel air cycle machine, a four-wheel air cycle machine, etc.

In the illustrated, non-limiting embodiments, the ACS 20 includes a single thermodynamic device 40. However, embodiments including two or more thermodynamic devices are also contemplated herein. The thermodynamic device 40 may include a compressor 42 and at least one turbine operably coupled thereto by a shaft 44. In the non-limiting embodiments shown in the FIGS. the thermodynamic device 40 includes two turbines 46 and 48. In such embodiments, a medium, such as the medium A1 for example, may be configured to flow through one or more the plurality of turbines 46, 48 based on a mode of operation.

The compressor 42 is a mechanical device configured to raise a pressure of a medium and can be driven by another mechanical device (e.g., a motor or a medium via a turbine). Examples of compressor types include centrifugal, diagonal or mixed-flow, axial-flow, reciprocating, ionic liquid piston, rotary screw, rotary vane, scroll, diaphragm, air bubble, etc. A turbine, such as either turbine 46 and 48 for example, is a mechanical device that expands a medium and extracts work therefrom (also referred to as extracting energy). This extracted energy is transmitted to the shaft of the turbine and the other components operably coupled thereto, such as a compressor 42 for example.

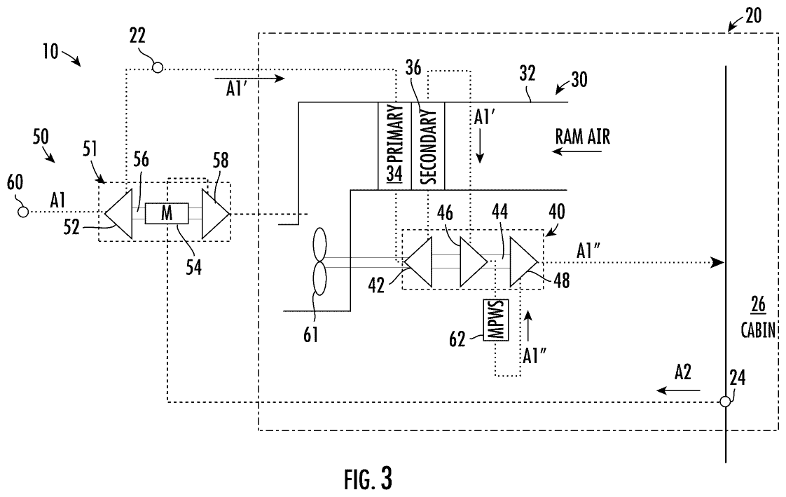

In an embodiment, the ACS 20 includes a fan 61. A fan 61 is a mechanical device that can force via push or pull methods air through the shell of the ram air duct, across at least a portion of the ram air heat exchangers. In an embodiment, such as shown in FIG. 1, the fan 61 is a component separate from a thermodynamic device 40 and is driven by any suitable means, such as a motor for example. However, in other embodiments, the fan 61 may be operably coupled to the thermodynamic device 40. For example, in the non-limiting embodiment of FIG. 3, the fan 61 is coupled to and is driven by the shaft 44 of the thermodynamic device 40. Integration of the fan 61 into the thermodynamic device 40 eliminates the weight of the electric motor and the motor controller needed to drive the electric ram fan.

The elements of the ACS 20 are connected via valves, tubes, pipes, and the like. Valves (e.g., flow regulation device or mass flow valve) are devices that regulate, direct, and/or control a flow of a medium by opening, closing, or partially obstructing various passageways within the tubes, pipes, etc. of the system. Valves can be operated by actuators, such that flow rates of the medium in any portion of the system can be regulated to a desired value.

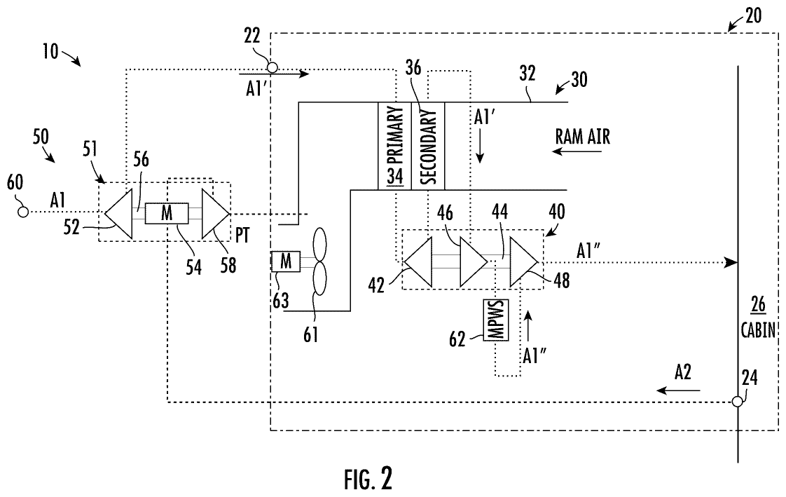

The ECS 10 may additionally include an air supply system 50 fluidly connected to the ACS 20 relative to a flow of the first medium A1. In the illustrated non-limiting embodiment, the air supply system 50 is located upstream from the inlet 22 of the ACS 20 relative to the flow of the first medium A1. The air supply system 50 may include another thermodynamic device 51, such as a cabin air compressor (CAC) including a compressor 52 driven by another component. As shown in FIG. 1, the compressor 52 may be driven by a motor 54 operably coupled thereto. In the illustrated, non-limiting embodiment, the motor 54 is connected to the compressor 52 by a rotatable shaft 56. However, in other embodiments, such as shown in FIG. 2, as an alternative to or in addition to the motor 54, the thermodynamic device 51 of the air supply system 50 may include a turbine 58 operably coupled to the compressor 52 via the shaft 56. In such embodiments, energy extracted from a second medium A2 within the turbine 58 may be used to drive the compressor 52.

During operation of the ECS 10 of FIG. 1, a flow of first medium A1 is received at an inlet 60. From the inlet 60, the first medium A1 is provided to the compressor 52 of the thermodynamic device 51. The act of compressing the first medium A1 heats it. The resulting compressed first medium A1′ is provided to the inlet 22 of the downstream ACS 20. From the inlet 22, the flow of compressed first medium A1′ is provided to the primary heat exchanger 34 of the ram air circuit 30. A flow of ram air, moving through the ram air duct 32 via operation of the fan 61, is provided to the primary heat exchanger 34 to cool the compressed first medium A1′. The outlet of the heat exchanger 34 is fluidly connected to an inlet of the compressor 42 of the thermodynamic device 40. The cool compressed first medium A1′ output from the heat exchanger 34 is further compressed within the compressor 42, such that the compressed first medium A1′ output from the compressor 42 has a higher temperature and/or pressure than the compressed first medium A1′ provided to the inlet of the compressor 42.

An outlet of the compressor 42 is fluidly connected to an inlet of the secondary heat exchanger 36. Accordingly, the compressed first medium A1′ output from the compressor 42 is provided to an inlet of the secondary heat exchanger 36. Similar to the primary heat exchanger 34, the compressed first medium A1′ is cooled within the secondary heat exchanger 36 by the flow of ram air. In an embodiment, the compressed first medium A1′ is cooled within the secondary heat exchanger 36 to approximately ambient temperature. An outlet of the secondary heat exchanger may be fluidly coupled to an inlet of a turbine, such as the first turbine 46 for example, such that the compressed first medium A1′ is provided to the first turbine 46 downstream from the secondary heat exchanger 36. Within the first turbine 46, the compressed first medium A1′ is expanded and work is extracted therefrom to form an expanded first medium A1″. The work from the first turbine 46 may be used to drive the compressor 42.

During its expansion within the first turbine 46, the compressed first medium A1′ is further cooled and moisture within the compressed first medium A1′ is condensed to create an expanded first medium A1″. In an embodiment, the expanded first medium A1″ at the outlet of the first turbine 46 has a temperature close to freezing. The expanded first medium A1″ output from the first turbine 46 may be sent to a water extractor 62, where any free moisture in the expanded first medium A1″ is removed. The first turbine 46 and the water extractor 62, in combination, may be considered a mid-pressure water separator.

The resulting dry expanded first medium A1″ may then be provided to the second turbine 48 of the thermodynamic device 40 where it is further expanded and more work is extracted therefrom. Accordingly, the first medium A1 may be provided to the first turbine 46 and the second turbine 48 in series. Work extracted from the expanded first medium A1″ within the second turbine 48 may also be used to drive the compressor 42 via the shaft 44. From the second turbine 48, the expanded first medium A1″ may be delivered to one or more loads, such as the cabin 26 for example.

At the same time, a flow of the second medium A2 may be provided to the ACS 20 via the second inlet 24. As shown, the second medium A2 is used to remove heat from the motor 54 of the thermodynamic device 51 before being exhausted overboard or dumped into the ram air circuit. In an embodiment, the second medium A2 is exhausted into the ram air circuit at a location downstream from the heat exchangers 34, 36. In embodiments where the fan 61 is a tip turbine fan driven by another motor 63, the second medium exhausted in to the ram air circuit may be used to cool the another motor 63. The second medium A2 may be moved through the ECS 10 with a positive pressure. In some embodiments, the pressure of the second medium A2 is sufficient to drive movement through the ECS10; however, in some embodiments, the positive pressure is generated via a fan (not shown).

The system shown in FIGS. 2 and 3 are substantially identical to that of FIG. 1. However, in FIGS. 2 and 3, the thermodynamic device 51 includes a turbine 58 operably coupled to the compressor 52 via the shaft 56. In such embodiments, the second medium A2, after absorbing heat from the motor 54, is provided to an inlet of the turbine 58. In an embodiment, the temperature of the second medium A2 at an inlet of the turbine 58 is above 100° F. Work is extracted from the second medium A2 within the turbine 58 to create an expanded second medium A2. This energy extracted from the second medium A2 may reduce the power required by the motor 54 to drive the compressor 52 by as much as 30%. This reduction in power may lower the power provided by controller associated with the motor 54, thereby lowering its heat rejection. This lowers the heat load on a separate liquid cooling loop and in some embodiments, may eliminate the need for a liquid cooling loop all together.

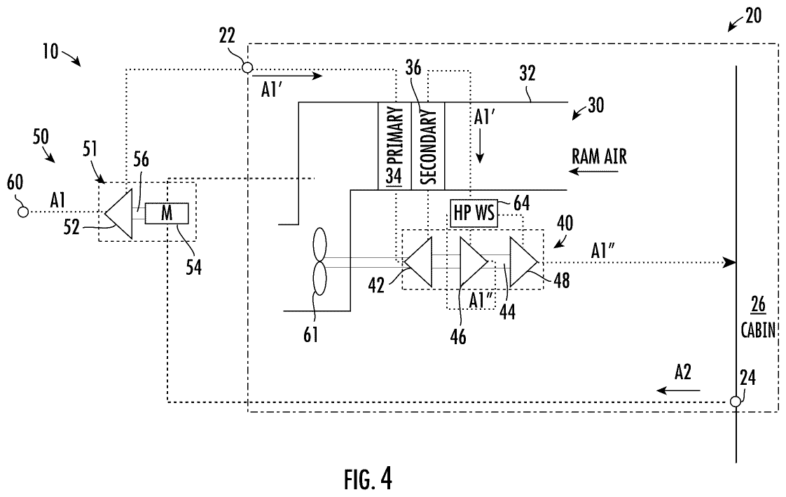

In the non-limiting embodiment of FIGS. 4-7, the various embodiments of an ACS 20 shown include a high-pressure water separator rather than a mid-pressure water separator. Accordingly, the high-pressure water separator 64 is arranged at a location within the ACS 20 where the first medium is at its highest pressure, such as upstream from the first turbine 46 relative to the flow of the compressed first medium A1′. Although not shown, the high-pressure water separator 64 may include a condensing heat exchanger and a water extractor arranged in series, with the water extractor being located directly downstream form the condensing heat exchanger. In such embodiments, within the secondary heat exchanger 36, the compressed first medium A1′ is cooled to a nearly ambient temperature.

This cool compressed first medium A1′ enters the condensing heat exchanger, where it is cooled by a flow of expanded first medium A1″ output from the first turbine 46. As the compressed first medium A1′ is cooled within the condensing heat exchanger, moisture is condensed from the compressed first medium A1′. The compressed first medium A1′ then enters the water extractor where any free moisture in the compressed first medium A1′ is removed. This cool dry compressed first medium A1′ then enters the first turbine 46 where it is expanded and work extracted to form an expanded first medium A1″. The act of extracting work from the compressed first medium A1′ within the turbine 46 cools the compressed first medium A1′.

From the first turbine 46, the resulting expanded first medium A1″ is configured to make a second pass through the condensing heat exchanger of the high-pressure water separator 64. Within the condensing heat exchanger, the expanded first medium A1″ is heated by the compressed first medium A1′. From the high-pressure water separator 64, the warmed expanded first medium A1″ may be provided to the second turbine 48 for further expansion. The resulting expanded first medium A1″ output from the second turbine 48 may similarly be delivered to one or more downstream loads.

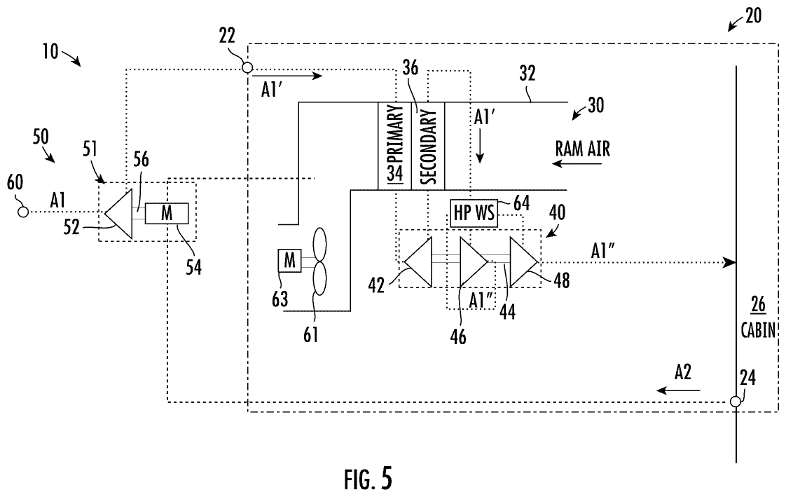

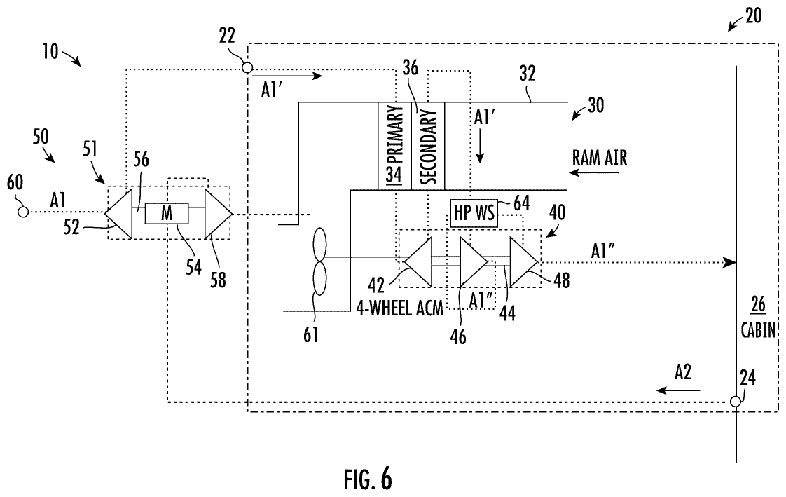

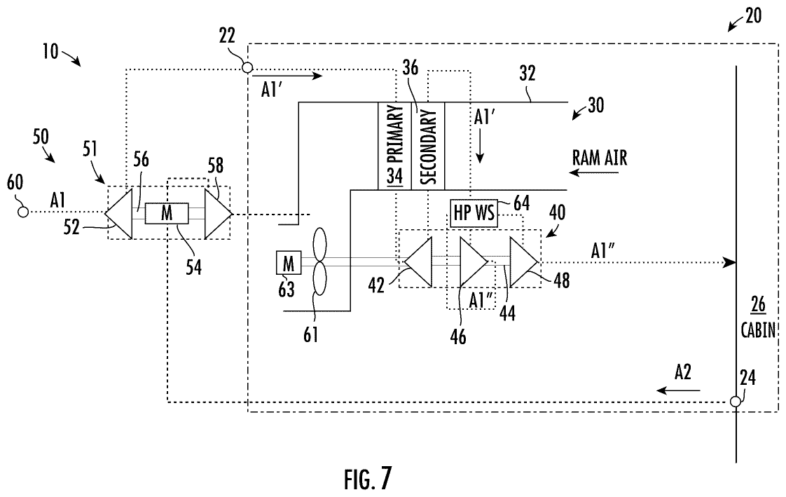

In the non-limiting embodiments of FIGS. 4 and 5, the second medium A2 is exhausted overboard or into the ram air circuit 30 after absorbing heat from the motor 54. However, in the non-limiting embodiments of FIGS. 6 and 7, the hot second medium A2 is additionally provided to the turbine 58 of the thermodynamic device 51 to extract energy therefrom before being exhausted overboard or into the ram air circuit 30.

An ACS 20 including a mid-pressure water separator (FIGS. 1-3) condenses moisture in a significantly different way than an ACS 20 having a high-pressure water separator 64 (FIGS. 4-7). A high-pressure water separator 64 uses heat transfer in the condensing heat exchanger to condense moisture within the fluid flow. A mid-pressure water separator uses expansion and work extraction from the medium within a turbine to condense the moisture within the fluid flow. The advantages of the mid-pressure water separator are straight forward. First, it eliminates the weight of the condensing heat exchanger. Second, it eliminates many of the ducts associated with the high-pressure water separator 64, and also the parasitic losses and pressure drop, associated with those components. The end result is a lighter system that uses less energy to cool the cabin and flight deck. In an embodiment, a system as described herein having a mid-pressure water separator may have a 5% weight reduction compared to a corresponding system including a high-pressure water separator 64.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An environmental control system of a vehicle, the environmental control system comprising:
an air conditioning system having a first inlet configured to receive a first medium and a second inlet configured to receive a second medium;
an air supply system including a thermodynamic device fluidly coupled to the air conditioning system, the thermodynamic device including a compressor operably coupled to an electric motor and a turbine by a shaft; and
wherein the thermodynamic device is fluidly coupled to and is arranged upstream from the first inlet relative to a flow of the first medium and the thermodynamic device is fluidly coupled to and is arranged downstream from the second inlet relative to a flow of the second medium;
wherein the electric motor is fluidly coupled to an inlet of the turbine, the turbine being arranged directly downstream from the electric motor relative to the flow of the second medium.

2. The environmental control system of claim 1, wherein the flow of the second medium is operable to remove heat from the electric motor.

3. The environmental control system of claim 1, wherein the flow of the second medium is configured to make a plurality of passes over the electric motor.

4. The environmental control system of claim 1, wherein the air conditioning system includes a ram air circuit having at least one ram heat exchanger and an outlet of the turbine is fluidly connected to the ram air circuit at a location downstream from the at least one ram heat exchanger.

5. The environmental control system of claim 4, wherein the compressor has a compressor outlet, the compressor outlet being fluidly connected to and arranged in series with the at least one ram heat exchanger.

6. The environmental control system of claim 5, wherein the compressor outlet is directly fluidly connected to the at least one ram heat exchanger.

7. The environmental control system of claim 1, wherein in a mode, the compressor is driven solely by the electric motor.

8. The environmental control system of claim 7, wherein in another mode, the compressor is driven by the electric motor and by energy extracted from the second medium at the turbine.

9. The environmental control system of claim 1, wherein the air conditioning system includes another thermodynamic device, the another thermodynamic device having a compressor and at least one turbine operably coupled by a shaft.

10. The environmental control system of claim 9, wherein the at least one turbine of the another thermodynamic device includes a first turbine and a second turbine, the first turbine and the second turbine being arranged in series relative to a flow of the first medium.

11. The environmental control system of claim 10, further comprising a water extractor positioned directly downstream from an outlet of the first turbine, wherein the first turbine and the water extractor, in combination, form a mid-pressure water separator.

12. The environmental control system of claim 1, wherein the environmental control system is part of an aircraft and the second medium is cabin air.

13. A method of operating an environmental control system of a vehicle, the method comprising:
compressing a first medium at an air supply system to form a compressed first medium, the air supply system including a thermodynamic device fluidly coupled to an air conditioning system, the thermodynamic device including a compressor operably coupled to an electric motor and a turbine by a shaft;
cooling the electric motor via a flow of second medium provided from the air conditioning system; and
extracting energy from the flow of second medium at the turbine to form an expanded second medium, wherein the extracting energy occurs directly downstream from the electric motor.

14. The method of claim 13, further comprising exhausting the expanded second medium from the turbine into a ram air circuit of the air conditioning system.

15. The method of claim 14, wherein the ram air circuit includes at least one ram heat exchanger, and exhausting the expanded second medium into the ram air circuit occurs at a location downstream from the at least one ram heat exchanger.

16. The method of claim 15, further comprising cooling the compressed first medium within the at least one ram heat exchanger.

17. The method of claim 16, wherein cooling the compressed first medium within the at least one ram heat exchanger occurs directly downstream from compressing the first medium to form the compressed first medium.

18. The method of claim 16, wherein cooling the compressed first medium within the at least one ram heat exchanger includes drawing a flow of ram air through the ram air circuit via a fan.

19. The method of claim 18, wherein the fan is driven by another motor, the method further comprising cooling the another motor with the expanded second medium.
